(19) United States
(12) Patent Application Publication
(10) Pub. No.: US 2009/0235769 A1
(43) Pub. Date: Sep. 24, 2009

(54) Device in connection with transmission

(75) Inventor: Klas Karlsson, Kista (SE)

Correspondence Address: YOUNG & THOMPSON, 209 Madison Street, Suite 500, ALEXANDRIA, VA, 22314, US

(73) Assignee: Aritco Lift AB, Kungsangen (SE)

(21) Appl. No.: 11/922,328

(22) PCT Filed: Jun. 13, 2006
(86) PCT No.: PCT/SE2006/000695

§ 371 Date: Dec. 17, 2007

(30) Foreign Application Priority Data
Jun. 16, 2005 (SE) 0501365.1

(51) Int. Cl. F16H 25/24

(52) U.S. Cl. 74/424.71

(57) ABSTRACT

A device in connection with transmission, preferably in relation with low-speed lifts, the device including an externally threaded rod (1), a nut (3) that is mounted on the rod (1), and elements to rotate the nut (3). The nut that is included in a device in connection with transmission is also disclosed. It is significant of the device that the nut (3) is equipped with a bevel (9) in the area of one thread entry.

### TECHNICAL FIELD OF THE INVENTION

The present invention relates to a device in connection with transmission, preferably in relation with low-speed lifts, said device comprising an externally threaded rod, a nut that is mounted on the rod, and means to rotate the nut. The invention relates per se to a nut that is included in the device in connection with transmission.

### PRIOR ART

It is common that so called low-speed lifts has a device in connection with transmission that comprises at least an externally threaded rod, said rod being suspended in a suitable manner at its upper end while the lower end is free. The rod is locked against rotation. A nut is mounted on the rod and adjacent to the nut there is means to rotate the nut, said means normally constituting an electric motor. When the nut rotates the nut will be displaced relative to the rod in its longitudinal direction.

The thread of the rod normally being manufactured by means of roll forming, which means that the tolerance width of the portions that form the bottom of the thread is extremely narrow. However, this is not the case as regards the portions of the rod that form the crests of the thread. The external diameter of the rod, said diameter being defined by the crests of the thread, does not define a perfect circle but notches or the like may be present along the circumference. This means that the nut “hooks on to” the external diameter of the rod and since the rod is hanging freely, i.e. there is no guiding at the area of the lower end of the rod, the rod will vibrate or even have a tendency to perform natural vibration during certain circumstances. The basic structural principle of this known device for transmission will be described below with reference to a figure.

### OBJECTS AND FEATURES OF THE INVENTION

A primary object of the present invention is to present a device for transmission and a nut being included in said device, the vibrations generated in said device being reduced to a substantial degree compared to prior art.

A further object of the present invention is to reduce the tendency of natural vibrations of the threaded rod and/or nut included in the device.

Still an object of the present invention is that only a part of the device according to prior art needs to be exchanged.

At least the primary object of present invention is realized by means of a device that has been given the features of the appending independent claims. Preferred embodiments of the invention are defined in the dependent claims.

### BRIEF DESCRIPTION OF THE DRAWINGS

Below an example of prior art will be described as well as a preferred embodiment of the present invention, reference being made to the accompanying drawings, where:

Figure A shows schematically a device for transmission according to prior art;

Figure B shows a section along B-B in Figure A, the threaded rod not being sectioned for clarity reasons;

FIG. 1 shows schematically how the device according to the present invention is integrated in a lifting device;

FIG. 2 shows a device for transmission according to the present invention;

FIG. 3 shows a section along III-III in FIG. 2, the threaded rod not being sectioned for clarity reasons; and

FIG. 4 shows a longitudinal section through a nut that forms a part of the device according to FIG. 2.

### DETAILED DESCRIPTION OF AN EXAMPLE OF PRIOR ART AND A PREFERRED EMBODIMENT OF THE PRESENT INVENTION

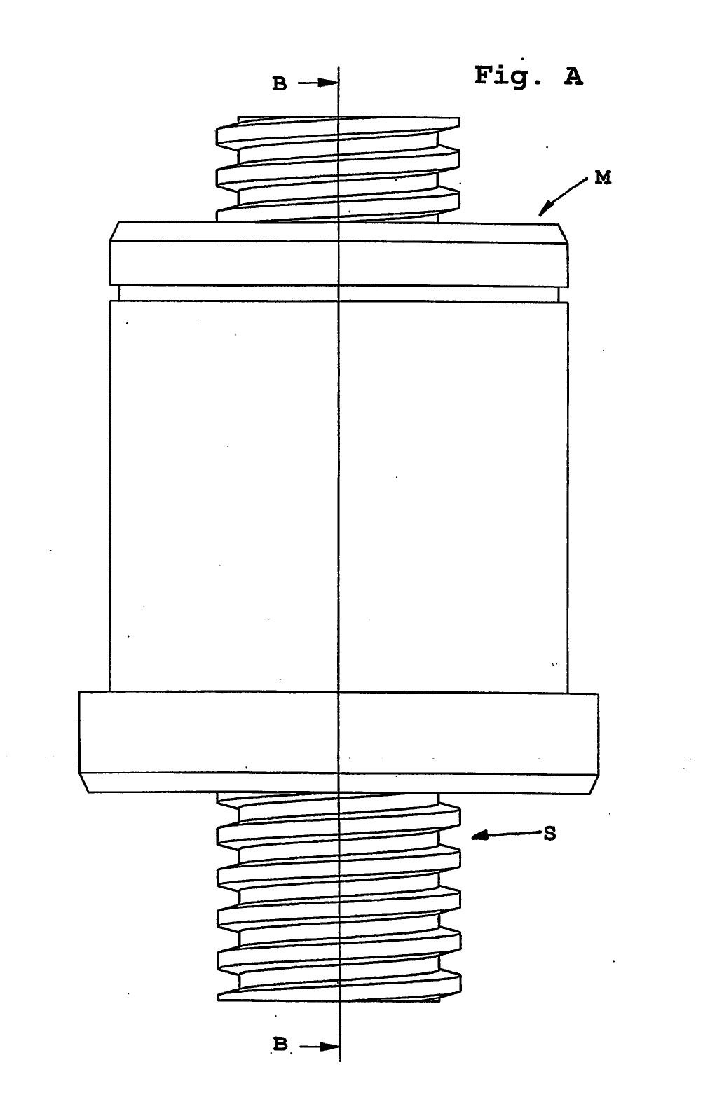

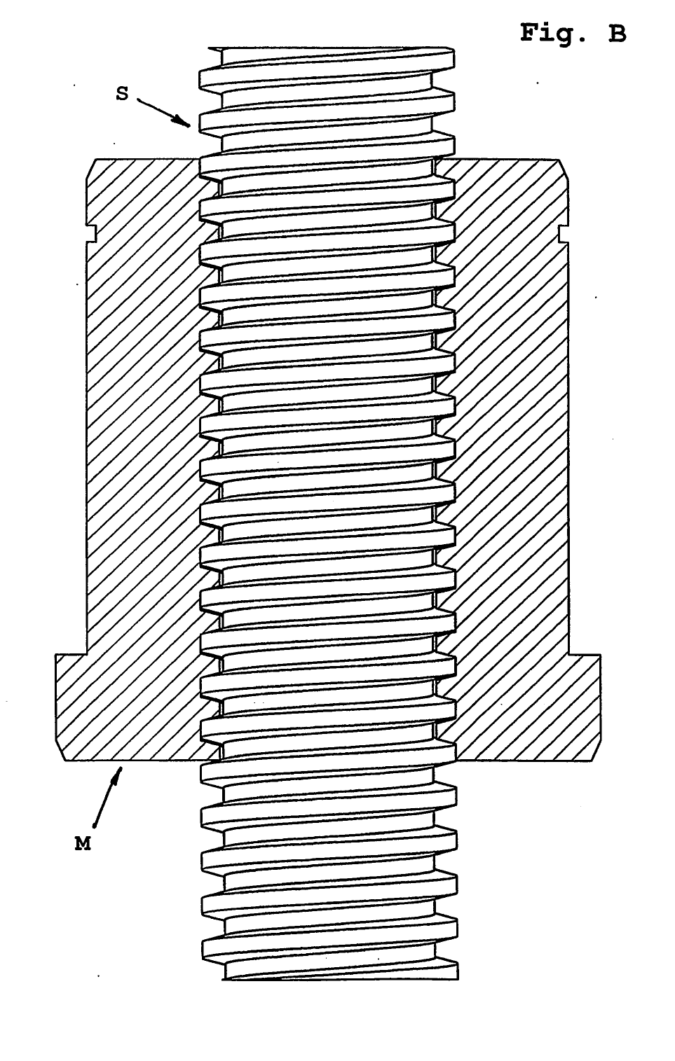

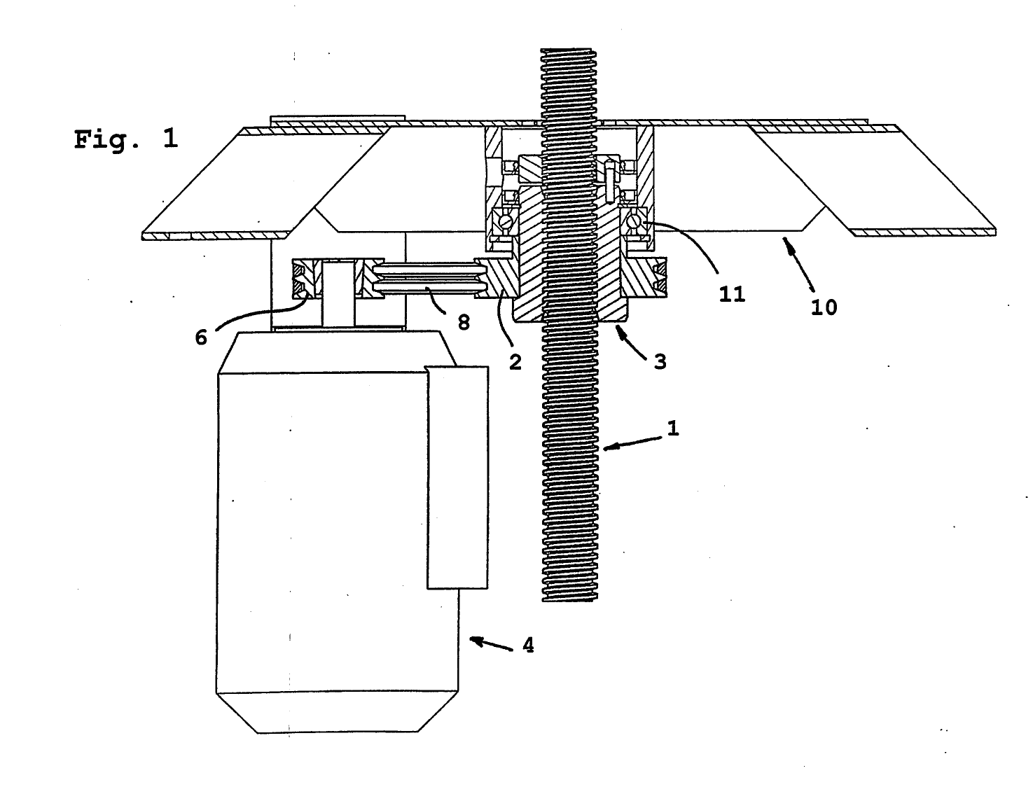

The transmission device shown in Figure A according to prior art comprises an externally threaded rod S and a nut M mounted on the rod S. The transmission device functions in such a way that the nut M is rotated while the rod S is locked against rotation. The nut M may be mounted on a part of the lift cage or the platform that is given a vertical movement. The principal of this will be described more in detail below in connection with FIG. 1. Since the external circumference of the rod S does not define a sufficiently perfect circular cylinder vibrations will be generated when the nut M “climbs” the rod S. These vibrations are initiated when the entries of the thread, at respective ends of the nut M, contact the portions of the rod S that is bypassed during the relative movement between the nut M and the rod S. As is most evident from Figure B the thread of the nut M has an essentially constant diameter along the entire extension of the nut in the longitudinal direction of the rod S. This means that when an irregularity of the external circumference of the rod S engages a thread entrance of the nut M vibrations will be initiated in the rod S, said vibrations possibly may cause the rod S and/or the nut M to perform natural vibration.

The lifting device, schematically shown in FIG. 1, said lifting device for instance being included in a low-speed lift, comprises an externally threaded rod 1 and a nut 3 that is mounted on the rod 1. The rod 1 is suspended in the area of its upper end (not shown) and is locked against rotation. The lower end of the rod 1 is not guided, i.e. the rod 1 hanging freely. A first pulley 2 is mounted on the nut 3. A prime mover 4, preferably an electric motor, is included in the lifting device shown in FIG. 1. A second pulley 6 is mounted on the output shaft of the prime mover 4. Two driving belts 8 extend around both pulleys 2, 6.

The nut 3 is rotatably suspended in a frame 10 or the like of the lifting device, the rotatable suspension being effected by means of a ball bearing 11. As is evident from FIG. 1 also the electric motor 4 is suspended in the frame 10.

The device, schematically shown in FIG. 1, functions essentially in such a way that the electric motor 4 rotates the nut 3, via the pulleys 2, 6 and the driving belts 8. This causes the nut 3 to move relative to the rod 1 since the rod 1 is locked against rotation. In the nut 3 moves upwards or downwards relative to the rod 1 depends of course from the rotary direction of the nut 3.

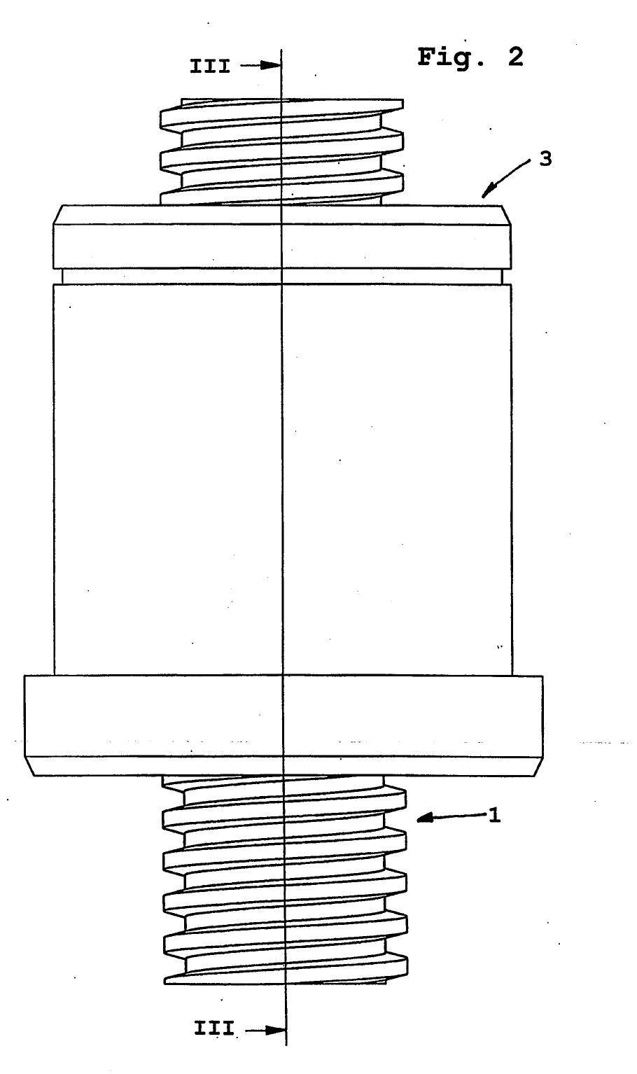

The transmission device according to the present invention, shown more in detail in FIGS. 2-4, thus comprises an externally threaded rod 1, a nut 3 mounted on the rod 1 and means 2, 4, 6, 8 to rotate the nut 3, said means 2, 4, 6, 8 being omitted in FIGS. 2-4. The rotational frequency range that is applicable to the nut 3, in connection with the present invention, is 200-3000 RPM.

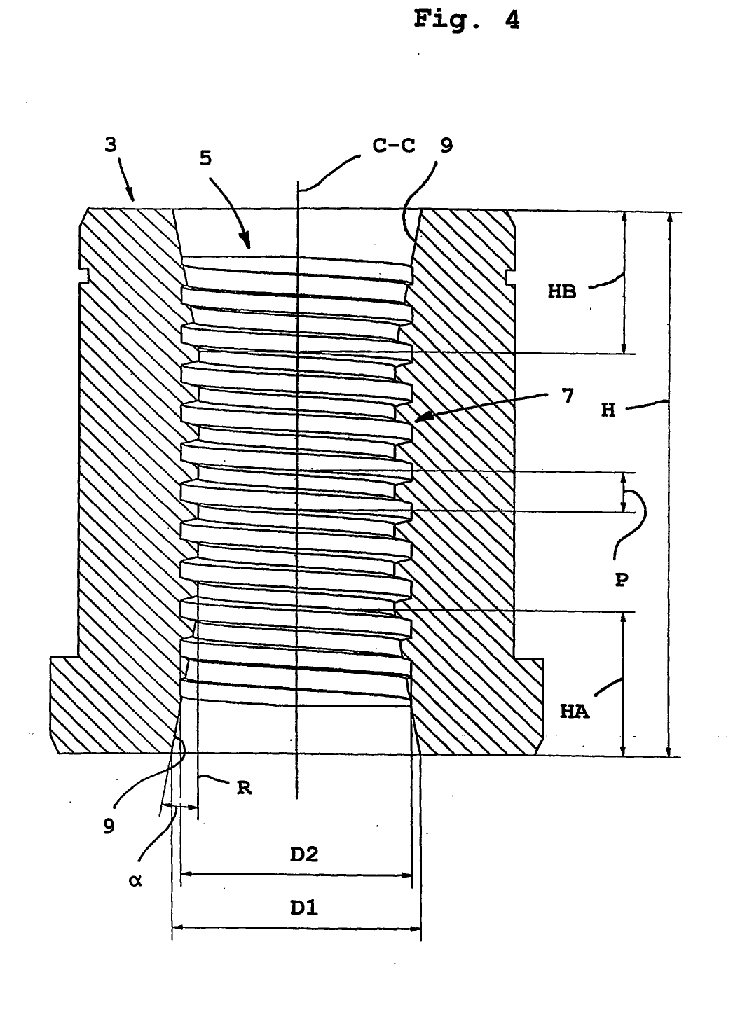

The nut 3 that is included in the device according to the present invention is shown separately in FIG. 4, said figure showing a longitudinal section through the nut 3. In FIG. 4 the centre axis C-C of the nut 3 is shown, said centre axis C-C also constituting the rotation axis of the nut 3. As is evident from FIG. 4 the nut 3 has a thread 5 that extends along a major portion of the height H of the nut 3, i.e. its extension along the longitudinal direction of the rod 1. In an intermediate portion 7 the thread 5 has a constant diameter while the thread 5 is equipped with bevels 9 in the area of its both entries. The bevels 9 are in the shape of conical surfaces that have symmetry of rotation in relation to the centre axis C-C. In order to define the bevels 4 a reference line R is drawn in FIG. 4, said reference line R being parallel to the centre axis C-C. The angle that the bevel 9 forms with the reference line R is designated by α in FIG. 4, the value of this angle should be in the interval 2°≦α≦35°, preferably said angle being in the interval 5°≦α≦15°.

In FIG. 4 the largest diameter D1 of the bevels 9 and the diameter D2 of the thread 5 are marked. The relation D1≧D2 is valid between said diameters.

In FIG. 4 the height H of the nut 3 is marked as well as the dimensions HA and HB that define the extension of the bevels 9 in the height of the nut 3. Within the scoop of the present invention it is not necessary that HA=HB, i.e. that the bevels 9 have the same height.

The height H of the nut 3 should according to the invention have a certain relation to the dimensions HA, HB and the pith of the thread 5, said pitch being designated by P in FIG. 4. As regards the embodiment of the nut 3, shown in FIG. 4,

H≧HA+HB+P. It is then assumed that the portion 7, having constant diameter, at least constitute one revolution of the thread, said portion 7 having an extension in axial direction that corresponds to the pitch of the thread 5. As is evident from FIG. 4 the portion 7 has an essentially longer axial extension. In exemplifying and non-restricting purpose it may be mentioned that the portion 7 of constant diameter has an axial extension of preferably 4-8 P, with a preferred value of 6 P, P being the pitch of the thread. From a functional point of view the object of the portion 7 with constant diameter is to effect a stabilisation of the nut 3 relative to the rod 1, i.e. the portion 7 with constant diameter prevents the nut 3 to wobble relative to the rod 1.

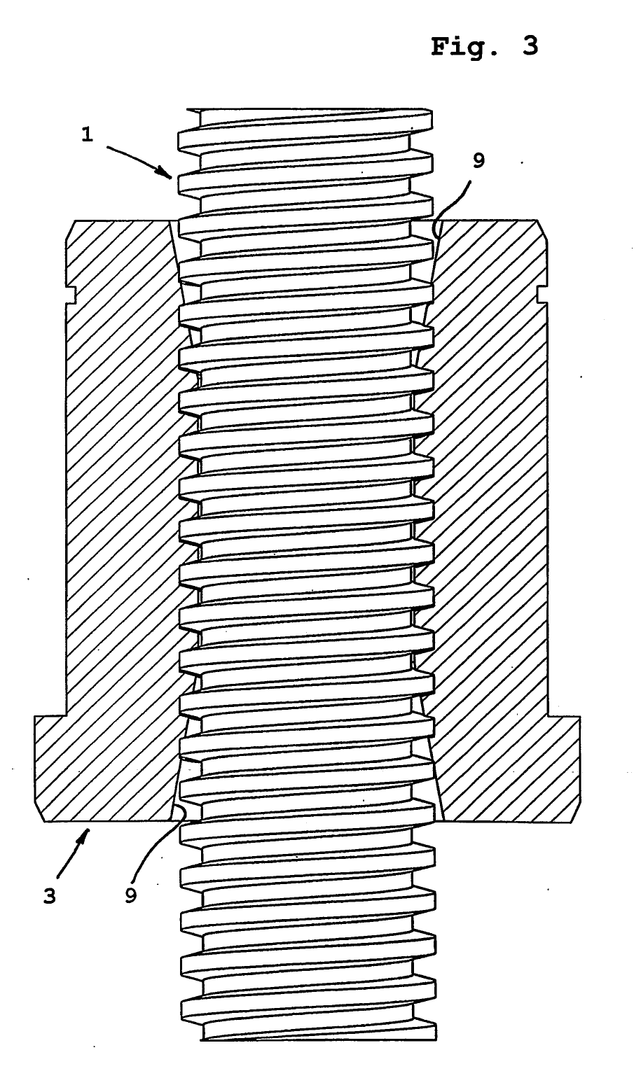

When studying FIG. 3 it is realized that when a certain portion of the rod 1 engages one thread entry of the nut 3, said engagement will be more gentle and initiate less vibrations, if the thread entries are located in the bevels 9.

An obvious advantage of the present invention is that in the future it will be possible to use rods 1 of the type that have been used earlier. The nut 3 according to the present invention thus compensate the lack of roundness of the rods 1.

### FEASIBLE MODIFICATIONS OF THE INVENTION

In the above described embodiment of the nut 3 bevels are provided in the area of both ends of the nut 3. Within the scoop of the present invention it is however feasible that the nut has a bevel only in the area of one end. If we assume that the nut is equipped only with the upper bevel in FIG. 4 the following relation is valid H≧HA+P.

1. Device in connection with transmission, preferably in relation with low-speed lifts, said device comprising an externally threaded rod (1), a nut (3) that is mounted on the rod (1), and that the nut (3) is equipped with a bevel (9) in the area of one thread entry, characterised in that the device has means to rotate the nut (3), that the nut (3) has a portion (7) of constant diameter, and that the portion (7) of constant diameter has an axial extension of at least one thread revolution (P).

2. Device according to claim 1, characterised in that the portion (7) of constant diameter has an axial extension of 4-8 thread revolutions.

3. Device according to claim 1, characterised in that the nut (3) is provided with bevels (9) in the areas of its both thread entries.

4. Device according to claim 1, characterised in that the bevel/the bevels (9) is/are in the shape of conical surfaces that have symmetry of rotation in relation to a centre axis (C-C) of the nut (3).

5. Device according to claim 4, characterised in that in an arbitrary plane that holds the centre axis (C-C) the conical surface creates an angle (α) with the centre axis (C-C), and that the angle is in the interval 2°≦α≦35°, preferably in the interval 5°≦α≦15°.

6. Device according to claim 1, characterised in that the nut (3) has an extension/height (H) in the longitudinal direction of the rod (1), that the thread (5) of the nut (3) has a pitch (P), and that the extension (HA/HB) of the bevel (9) in the height direction of the nut (3) is defined by the relation H≧HA/HB+P.

7. Device according to claim 3, characterised in that the nut (3) has an extension/height (H) in the longitudinal direction of the rod (1), that the thread (5) of the nut (3) has a pitch (P), and that the extension (HA, HB) of the bevels (9) in the height direction of the nut (3) is defined by the relation H≧HA+HB+P.

8. Nut (3) intended to be included in a device for transmission, said nut (3) being intended to be mounted on an externally threaded rod (1), and that the nut (3) is equipped with a bevel (9) in the area of one thread entry, characterised in that the nut (3) has a portion (7) of constant diameter, and that the portion (7) of constant diameter has an axial extension of at least one thread revolution (P).

9. Nut (3) according to claim 8, characterised in that the portion (7) of constant diameter has an axial extension of 4-8 thread revolutions.

10. Nut (3) according to claim 8, characterised in that the nut (3) is provided with bevels (9) in the areas of its both thread entries.

11. Nut (3) according to claim 8, characterised in that the bevel/the bevels (9) is/are in the shape of conical surfaces that have symmetry of rotation in relation to a centre axis (C-C) of the nut (3).

12. Nut (3) according to claim 11, characterised in that in an arbitrary plane that holds the centre axis (C-C) the conical surface creates an angle (α) with the centre axis (C-C), and that the angle is in the interval 2°≦α≦35°, preferably in the interval 5°≦α≦15°.

13. Nut (3) according to claim 8, characterised in that the nut (3) has an extension/height (H) in the longitudinal direction of the rod (1), that the thread (5) of the nut (3) has a pitch (P), and that the extension (HA/HB) of the bevel (9) in the height direction of the nut (3) is defined by the relation H≧HA/HB+P.

14. Nut (3) according to claim 10, characterised in that the nut (3) has an extension /height (H) in the longitudinal direction of the rod (1), that the thread (5) of the nut (3) has a pitch (P), and that the extension (HA, HB) of the bevels (9) in the height direction of the nut (3) is defined by the relation H≧HA+HB+P.

15. Device according to claim 2, characterised in that the nut (3) is provided with bevels (9) in the areas of its both thread entries.

16. Device according to claim 2, characterised in that the bevel/the bevels (9) is/are in the shape of conical surfaces that have symmetry of rotation in relation to a centre axis (C-C) of the nut (3).

17. Nut (3) according to claim 9, characterised in that the nut (3) is provided with bevels (9) in the areas of its both thread entries.

18. Nut (3) according to claim 9, characterised in that the bevel/the bevels (9) is/are in the shape of conical surfaces that have symmetry of rotation in relation to a centre axis (C-C) of the nut (3).

19. Nut (3) according to claim 10, characterised in that the bevel/the bevels (9) is/are in the shape of conical surfaces that have symmetry of rotation in relation to a centre axis (C-C) of the nut (3).
